(19) United States
(12) Patent Application Publication
(10) Pub. No.: US 2016/0336770 A1
(43) Pub. Date: Nov. 17, 2016

(54) BATTERY MANAGEMENT SYSTEM FOR MONITORING AND REGULATING THE OPERATION OF A BATTERY AND BATTERY SYSTEM HAVING SUCH A BATTERY MANAGEMENT SYSTEM

(71) Applicant: ROBERT BOSCH GMBH, Stuttgart (DE)

(72) Inventors: Stefan Benz, Stuttgart (DE); Joerg Schneider, Stuttgart (DE); Karsten Haug, Stuttgart (DE); Stefan Butzmann, Schalksmühle (DE)

(73) Assignee: ROBERT BOSCH GMBH, Stuttgart (DE)

(21) Appl. No.: 15/110,137

(22) PCT Filed: Dec. 30, 2014
(86) PCT No.: PCT/EP2014/079424

§ 371 Date: Jul. 7, 2016

(30) Foreign Application Priority Data
Jan. 8, 2014 (DE) 10 2014 200 096.3

(51) Int. Cl. H02J 7/00

(52) U.S. Cl. CPC H02J 7/0026; H02J 7/007; H02J 2007/0096

(57) ABSTRACT

The invention relates to a battery management system (1) for monitoring and regulating the operation of a rechargeable battery, comprising a plurality of battery cells, said rechargeable battery comprising a control device unit (2), a plurality of cell monitoring units (3), each assigned to at least one battery cell, a communication system (5) for transmitting and/or receiving data, and an isolating apparatus (4) for galvanic isolation of the battery from a consumer and/or a charging apparatus, wherein the isolating apparatus (4) is designed to receive data. The isolating apparatus (4) comprises an evaluating unit, which evaluates data received by the isolating apparatus (4) in respect of a demand to separate the battery from a consumer and/or a charging apparatus. The invention further relates to a battery system having a rechargeable battery which comprises a plurality of battery cells and a battery management system (1) according to the invention for monitoring and regulating the operation of the battery.

### BACKGROUND OF THE INVENTION

The invention relates to a battery management system for monitoring and regulating the operation of a rechargeable battery, comprising a plurality of battery cells, said battery management system comprising a control device unit, a plurality of cell monitoring units, each assigned to at least one battery cell, a communication system for transmitting and/or receiving data, and an isolating apparatus for galvanic isolation of the battery from a consumer and/or a charging apparatus, wherein the isolating apparatus is designed to receive data.

The invention further relates to a battery system having a rechargeable battery which comprises a plurality of battery cells and a battery management system for monitoring and regulating the operation of the battery.

Battery management systems are known in the prior art, for example, from the World Intellectual Property Organization publication WO 2010/118039 A1. Battery management systems of the type mentioned above are used in battery systems which comprise a battery having a plurality of battery cells that are electrically connected to one another, in particular rechargeable lithium-ion cells, said battery management systems being used particularly to monitor and control the operation of the battery. The operation of the battery of a battery system particularly comprises the discharging process of a battery, i.e. particularly the use of such a battery with a corresponding electrical consumer, as well as the charging process of the battery, i.e. the recharging of a battery. In this way, the battery management system typically ensures the reliable operation of the battery while taking into account the safety, performance and/or service life requirements to be placed on the battery.

In battery management systems known up until now, the cell voltages of the battery cells are acquired as measured values by a plurality of cell monitoring units, so-called cell supervising circuits (CSCs) and transmitted via a communication bus to a central control device unit, the so-called battery control unit (BCU). Measured currents measured by a current sensor can furthermore be transmitted to the control device unit as additional measured values. By evaluating the measured data, the battery control unit determines the battery properties, such as inter alia the charging state of individual battery cells, which is also referred to a state of charge (SOC) as well as the ageing of individual battery cells, which is also referred to as state of health (SOH).

In addition, such battery management systems typically comprise contactors as an isolating apparatus for galvanic isolation of the battery from a consumer and/or a charging apparatus. Such an isolating apparatus is designed in this case to receive actuation signals as data, wherein the isolating apparatus is likewise actuated by means of the control device unit. The control device unit is especially assigned the task of electrically separating individual battery cells or a group of battery cells, such as, in particular, individual battery modules, from the pole connections of the battery by actuating the isolating apparatus if acquired measured data indicate a state of said battery cells which is critical to the safety and reliability of the system. Such an isolation of battery cells is of great importance for preventing greater damage to the battery as well as to a consumer apparatus that is supplied with electrical current by the battery or, respectively, a charging device that is recharging the battery.

In particular with regard to this aspect which is relevant to the safety of the system, there is the continuing need to further improve battery management systems and battery systems comprising battery management systems.

An aim of the present invention is therefore to provide a battery management system which is improved with regard to the safe and reliable operation of a battery system and which, when a demand is present for separating the battery from a consumer and/or a charging apparatus connected to said battery, is advantageously improved in the timely separation of said battery from the consumer and/or charging apparatus. In addition, the battery management system is to be advantageously improved with regard to a reliable detection of conditions of the battery cells which may be critical to the safety of the battery system.

### SUMMARY OF THE INVENTION

In order to meet this aim, a battery management system for monitoring and regulating the operation of a rechargeable battery, comprising a plurality of battery cells, is proposed, said battery management system comprising a control device unit, a plurality of cell monitoring units, each assigned to at least one battery cell, a communication system for transmitting and/or receiving data, and an isolating apparatus for galvanic isolation of the battery from a consumer and/or a charging apparatus, wherein the isolating apparatus is designed to receive data and said isolating apparatus comprises an evaluating unit, which evaluates data received by said isolating apparatus in respect of a demand to separate the battery from a consumer and/or a charging apparatus. By means of the evaluating unit, the isolating apparatus is virtually equipped with an “intelligence” in an advantageous manner, whereby the functionality of the isolating apparatus is and/or can be enhanced. The isolating apparatus of the battery management system according to the invention is therefore advantageously a battery disconnect unit (BDU) which is enhanced in the range of functions thereof.

Analog and/or digitized measurement variables and/or control signals particularly constitute the data received by the isolating apparatus of the battery management system. Provision is particularly made in an advantageous embodiment of the invention for the evaluating unit of the isolating apparatus to be designed to be able to carry out an additional safety check and thus further increase the safety and reliability of a battery system comprising a battery system according to the invention. According to an advantageous embodiment, the evaluating unit is particularly designed to verify evaluation results of the control device unit; thus enabling the isolating apparatus to advantageously galvanically separate the battery from a connected consumer and/or charging apparatus only when a demand to separate the battery from a consumer and/or a charging apparatus is made available in a verified manner.

By evaluating received data, the isolating apparatus is itself advantageously in a position to initiate a separation of the battery from a consumer and/or a charging apparatus, preferably without a corresponding trigger and/or actuating signal being transmitted from the control device unit to the isolating apparatus. The isolating apparatus preferably further comprises switching elements, preferably contactors, which, when opened, advantageously interrupt the high-voltage circuit between the battery and the consumer apparatus or, respectively, between the battery and the charging apparatus. In this context, an opening of the switching elements is preferably triggered by an actuating signal transmitted to the respective switching element, wherein the isolating apparatus is advantageously designed to generate the actuating signal. In an advantageous manner, the path within the battery management system which is critical for the safety and reliability thereof is shortened in such an advantageous embodiment because the data can be directly transmitted to the isolating apparatus and the longer signal path via the control device unit is not required. In addition, the control device unit can advantageously be embodied with a functionality that is exclusively not critical to the safety and reliability of the battery management system. As a result, the safeguarding requirements placed on the control device unit are advantageously simplified as well as the safeguarding effort associated therewith, whereby costs can be advantageously saved.

The control device unit of the battery management system according to the invention is preferably a central control device unit, in particular a so-called battery control unit (BCU). In this case, provision is particularly made for the control device unit to be designed to carry out central control tasks. Provision is particularly made for the control device unit to be connected via the communication system to the cell monitoring units for receiving data and for said control device to receive operating parameters, in particular battery cell voltages and/or battery cell temperatures. The data received are then evaluated by the control device unit. Within the scope of the evaluation, battery properties, such as, for example, the state of charge of battery cells (SOC) and/or the ageing condition of battery cells (SOH; SOH: state of health) are determined. In addition, the control device unit preferably comprises a communication interface, via which said control device unit can communicate with further control device units which do not belong to the battery management system. Because the battery management system according to the invention is particularly intended to be used in battery systems installed in hybrid, plug-in hybrid or electric vehicles, the control device unit of the battery management system can advantageously communicate via the communication interface with vehicle control devices, such as, for example, a so-called vehicle control unit (VCU). In this case, a VCU takes on functionalities like the coordination of the drive torque, the charging management and/or the control over vehicle operating states such as, for example, “charging”, “driving” or “parking”.

The cell monitoring units of the battery system according to the invention are preferably designed to especially take on sensor functions such as, in particular, acquiring battery cell voltages and/or battery cell temperatures and/or carrying out the charge equalization between the battery cells. Provision is particularly made for the cell monitoring units to be so-called cell supervision circuits (CSC).

According to a particularly advantageous embodiment of the invention, the isolating apparatus of the battery management system comprises a control device, which is designed to initiate a separation of the battery from a consumer and/or a charging apparatus as a function of the outcome of the evaluation by the evaluating unit. Provision is particularly made for the control device to be designed to actuate switching elements of the isolating apparatus, in particular contactors, particularly in such a way that the switching elements open by means of an actuation signal generated by the control device and thus a galvanic isolation of the battery from a consumer and/or a charging apparatus is carried out. Provision is particularly made for the evaluating unit of the isolating apparatus to signal to the control device of the isolating apparatus that a critical operating state exists, a critical operating state being detected by means of the evaluating unit. To this end, measurement data received by the isolating apparatus can especially be compared to predefined limit values using a comparator unit, wherein a predefined limit value being undershot or exceeded can indicate a critical operating state of the battery.

According to a further particularly advantageous embodiment of the battery management system according to the invention, the isolating apparatus is connected via the communication system to the cell monitoring units, in particular directly connected to the cell monitoring units, wherein the isolating apparatus is designed to receive operating parameters acquired by the cell monitoring units as data, particularly acquired battery cell voltages and/or battery cell temperatures. By means of this preferable direct communication between the cell monitoring units and the isolating apparatus, i.e. particularly between components for measuring the cell voltage and/or temperature and switching elements for galvanic isolation of the battery from a consumer and/or a charging apparatus, a shorter path that is critical for the safety and reliability of the system is implemented, in particular because operating parameters acquired by the cell monitoring units are not transmitted to the isolating apparatus via the control device unit of the battery management system.

The communication system of the battery management system is advantageously a serial bus system, preferably a CAN bus system. In so doing, data are advantageously transmitted within the battery management system using the CAN protocol. A transmission using the CAN protocol is advantageously particularly reliable and less susceptible to interferences.

According to a further advantageous embodiment of the battery management system according to the invention, said battery management system comprises at least one current measuring device for measuring an electric current of the battery, wherein the at least one current measuring device is connected to the isolating apparatus and said isolating apparatus is designed to receive currents measured by the at least one current measuring device as data. The current measurement can, for example, be implemented using a shunt. The at least one current measuring device can particularly be connected to the isolating apparatus via a so-called LIN bus (LIN: local interconnect network). A connection of the corresponding current measuring device to the control device unit of the battery management system, like what has been typical to date, can advantageously be omitted in this embodiment of the battery management system according to the invention. By means of the direct communication between the isolating apparatus and the at least one current measuring device, a shorter path critical for the safety of the system is implemented. As a result, the safety and reliability during operation of a battery with an inventive battery management system is further advantageously increased.

The isolating apparatus is further advantageously designed to receive at least one crash signal as data. This is particularly advantageous when using the battery management system according to the invention in a battery system used in a vehicle. Provision is thereby particularly made for a control device unit of the vehicle to generate a crash signal by evaluating measurement variables acquired by crash sensors, for example a crash signal which is used to trigger vehicle restraint systems, and to transmit this signal to the isolating apparatus. To this end, the isolating apparatus preferably has a separate communication interface. The crash signal is preferably recognized by the evaluating unit of the isolating apparatus as a crash signal, wherein, upon receiving a crash signal, a separation of the battery from a consumer and/or a charging apparatus is advantageously initiated, preferably by actuating contactors of the isolating apparatus.

According to a further particularly advantageous embodiment of the invention, the battery management system has a further communication system, the isolating apparatus being connected via the further communication system to the cell monitoring units. In a preferable manner, the isolating apparatus is furthermore connected to the cell monitoring units via the first communication system. The further communication system is then advantageously used for the redundant transmission of items of information that are relevant to the safety of the system, in particular for transmitting battery cell voltages and/or battery cell temperatures acquired by the cell monitoring units, particularly critical battery cell voltages and/or critical battery cell temperatures. The safety and reliability of the system is further advantageously increased by the further communication system. In addition, an ASIL decomposition (cf. ISO 26262) is advantageously made possible. The further communication system is advantageously implemented as a serial bus system.

Provision is particularly made for the further communication system to be a communication line connecting the cell monitoring units to one another, wherein data is transmitted from the cell monitoring units via the communication line to the isolating apparatus using the daisy chain principle. The further communication system is thereby preferably designed as a daisy chain alarm line, via which all information relevant to the safety of the system can preferably be transmitted between the cell monitoring units and the isolating apparatus.

According to a further advantageous embodiment of the battery management system according to the invention, the isolating apparatus is further designed to generate and/or monitor a HV interlock signal (HV: high voltage) using received data. In this way, the control of the switching elements of the isolating apparatus (contactor control) can advantageously be directly influenced. The HV interlock signal is advantageously a signal which is used to separate the high-voltage circuit between battery and consumer and/or charging apparatus.

Provision is made in a further advantageous embodiment of the invention for the battery management system to be connected in part to a high-voltage circuit and in part to a low-voltage circuit, the control device unit being exclusively connected to the low-voltage circuit. By virtue of the fact that the control device unit is exclusively operated at low-voltage potential (LV potential; LV: low voltage), the control device unit can advantageously be implemented in a more cost effective manner. Such an advantageous embodiment is advantageously implemented without sacrificing safety as a result of the control device unit not being used to actuate the isolating apparatus of the battery management system. Because, in accordance with the invention, the isolating apparatus of the battery management system has an autonomous intelligence due to the evaluating unit, said isolating apparatus is advantageously designed to evaluate received data and to advantageously use the evaluated data to actuate contactors of said isolating apparatus, preferably by means of a control device of said isolating apparatus.

In order to meet the aim mentioned at the beginning of the application, a battery system including a rechargeable battery, comprising a plurality of battery cells, and a battery management system for monitoring and controlling the operation of the battery is proposed, wherein the battery management system of the battery system is a battery management system according to the invention.

### BRIEF DESCRIPTION OF THE DRAWINGS

Further advantageous particulars, features and embodiment details of the invention are explained in greater detail in connection with the exemplary embodiments depicted in the drawings. In the drawings:

FIG. 1 shows a simplified depiction of an exemplary embodiment for a battery management system according to the invention in a block diagram; and

FIG. 2 shows a simplified depiction of a further exemplary embodiment for a battery management system in a block diagram.

### DETAILED DESCRIPTION

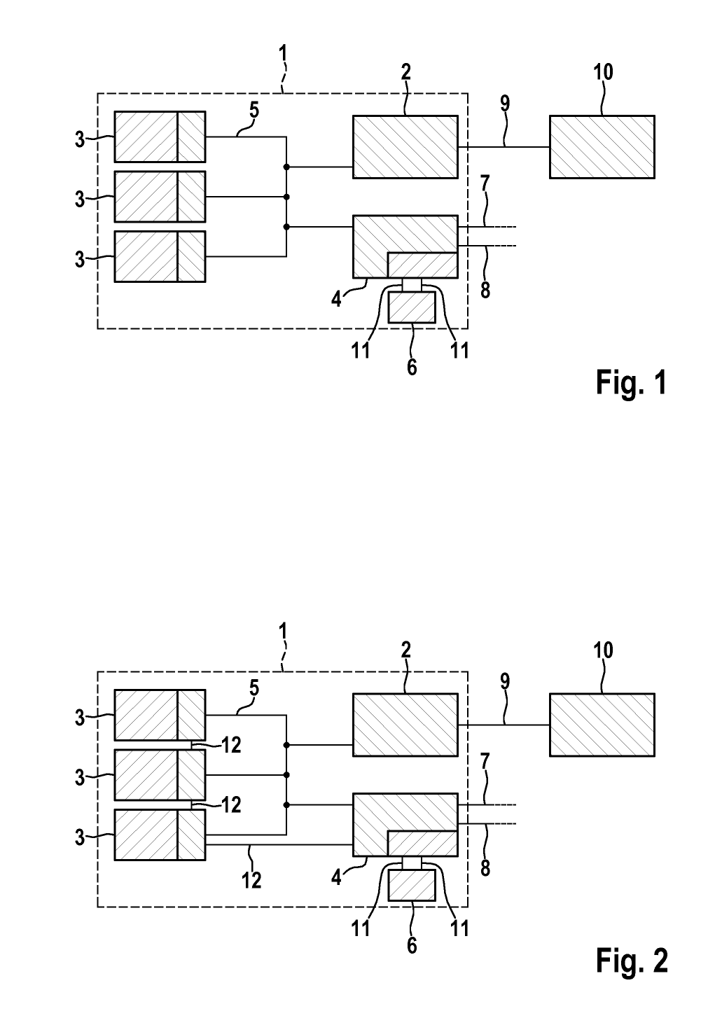

A battery management system 1 for monitoring and regulating the operation of a rechargeable battery, comprising a plurality of battery cells, is depicted in each case in FIG. 1 and FIG. 2. The battery management system comprises a control device unit 2, a plurality of cell monitoring units 3 (three cell monitoring units 3 are shown in each case in FIG. 1 and FIG. 2), an isolating apparatus 4 for galvanic isolation of the battery from a consumer and/or a charging apparatus, a communication system 5 and a current measuring device 6. A use of the battery management systems 1 depicted in FIG. 1 and FIG. 2 is particularly intended in battery systems installed in electric vehicles.

As indicated in FIG. 1 and FIG. 2 by the different hatchings, the battery management system 1 is connected in part to a high-voltage circuit (hatching from lower left to upper right) and in part to a low-voltage circuit (hatching from upper left to lower right). In an advantageous manner, the control device unit 2 is thereby connected in each case exclusively to the low-voltage circuit.

The control device unit 2 of the battery management system 1 depicted respectively in FIG. 1 and FIG. 2 is preferably designed as a battery control unit. The control device unit 2 is connected via a CAN bus 9 to a vehicle control device apparatus 10 for exchanging data. This vehicle control device apparatus 10 can particularly be a so-called vehicle control unit (VCU) which carries out functionalities such as the coordination of the drive torque, the charging management and/or the control over vehicle operating states, such as charging, driving, parking, etc. Data provided by the cell monitoring units 3 or data provided by the isolating apparatus 4 can advantageously be received by the control device unit 2 and be processed by the same. These data can particularly be transmitted from the control device unit 2 to the further vehicle control device apparatus 10 via the CAN bus 9.

The cell monitoring units 3 of the battery management system 1 are preferably cell supervision circuits (CSC) which are particularly designed to acquire operating parameters of a battery, in particular battery cell voltages and/or battery cell temperatures and to additionally carry out further functions, in particular a so-called cell balancing.

The isolating apparatus 4 of the battery management system 1 is preferably an advanced battery disconnect unit (BDU), which is particularly designed to interrupt the high-voltage circuit between a battery and a consumer apparatus and/or a charging apparatus via switching elements, preferably via contactors. In the exemplary embodiments depicted, the isolating apparatus 4 comprises in each case one evaluating unit (not explicitly depicted in the figures), which can especially be designed as a microcontroller circuit. In addition, the isolating apparatus 4 comprises a control device (not explicitly depicted in the figures), in particular a control device which is designed to actuate the switching elements of the isolating apparatus (not explicitly depicted in the figures).

As is schematically depicted in FIG. 1 and FIG. 2, the cell monitoring units 3 and the control device unit (2) as well as the cell monitoring units 3 and the isolating apparatus 4 are connected to one another for transmitting and/or receiving data via a communication system 5. The communication system 5 is preferably designed as a CAN bus system. The control device unit 2 and the isolating apparatus 4 can each exchange data with the cell monitoring units 3 via the communication system 5. The isolating apparatus 4 is particularly designed to receive data from the cell monitoring units via the communication system 5, in particular operating parameters acquired by the cell monitoring units 3, such as particularly battery cell voltages and/or battery cell temperatures.

The current measuring device 6 of the battery management system 1, which is preferably designed as a shunt, is connected to the isolating apparatus 4, preferably via a LIN bus 11. The isolating apparatus 4 is designed in this case to receive measured currents from the current measuring device 6 as data.

The isolating apparatus 4 is additionally designed to receive and evaluate a crash signal transmitted via the signal line 7 as data in order to initiate as required a galvanic isolation of the battery from a consumer and/or a charging apparatus. The isolating apparatus 4 is furthermore advantageously designed to monitor an HV interlock signal, which is provided to said isolating apparatus 4 via the signal line 8.

All of the data arriving via the communication system 5, via the signal line 7, via the signal line 8 and/or from the current measuring device 6 via the LIN bus 11 are advantageously evaluated by the evaluating unit of the isolating apparatus 4 in respect of a demand to separate the battery from a consumer and/or a charging apparatus. Operating parameters received via the communication system 5, such as battery cell voltages and/or battery cell temperatures that have been received, are particularly evaluated by the evaluating unit of the isolating apparatus 4 as to whether a critical operating state exists. To this end, operating parameters received can be subjected, in particular, to threshold value comparisons in order to determine whether operating parameters exceed or, respectively, undershoot predefined lower limit values and/or upper limit values. In addition, the evaluating unit of the isolating apparatus 4 is advantageously designed to evaluate the currents measured by the current measuring device 6 with respect to critical values. The evaluating unit is furthermore advantageously designed to evaluate a signal received via the signal line 7 as to whether a separation of the battery from a consumer apparatus and/or a charging apparatus is required due to a vehicle crash that has taken place.

The control device of the isolating apparatus 4 is advantageously designed to initiate a separation of the battery from a consumer and/or a charging apparatus as a function of the outcomes of the evaluation by the evaluating unit. The control device is thereby advantageously designed to actuate the switching elements of the isolating apparatus for separating the battery from a consumer and/or a charging apparatus in such a way that said switching elements open. The high-voltage circuit is advantageously interrupted by opening the switching element or switching elements. The control device of the isolating apparatus 4 is particularly designed to generate a control signal, the switching elements opening upon receiving the control signal.

The exemplary embodiment depicted in FIG. 2 is expanded with respect to the exemplary embodiment depicted in FIG. 1 by a further communication system 12. The further communication system 12 is then preferably a fieldbus. The further communication system 12 is used in this case to redundantly transmit data acquired by the cell monitoring units 3, in particular items of information relevant to the safety and reliability of the battery system, to the isolating apparatus 4. That means that the isolating apparatus 4 receives data from the cell monitoring units 3 via the communication system 5 as well as via the further communication system 12. In the exemplary embodiment depicted in FIG. 2, acquired data are transmitted from the cell monitoring units 3 to the isolating apparatus 4 using the so-called daisy chain principle. That means that one of the cell monitoring units 3 (the lowest cell monitoring unit in FIG. 2) is directly connected to the isolating apparatus 4, and the further cell monitoring units 3 are each connected to a further cell monitoring unit 3 (respectively to the cell monitoring unit which is correspondingly disposed higher in FIG. 2). In so doing, data are in each case transmitted from a cell monitoring unit 3 to the next cell monitoring unit 3 and from the last cell monitoring unit 3 finally to the isolating apparatus 4.

The exemplary embodiments depicted in the drawings and explained in conjunction with said drawings are used to explain the invention and are not descriptive for the same.

1. A battery management system (1) for monitoring and regulating the operation of a rechargeable battery, comprising a plurality of battery cells, said battery management system comprising a control device unit (2), a plurality of cell monitoring units (3), each assigned to at least one battery cell, a communication system (5) for transmitting and/or receiving data, and an isolating apparatus (4) for galvanic isolation of the battery from a consumer and/or a charging apparatus, wherein the isolating apparatus (4) is configured to receive data the isolating apparatus (4) including an evaluating unit, which evaluates data received by the isolating apparatus (4) in respect of a demand to separate the battery from a consumer and/or a charging apparatus.

2. The battery management system (1) according to claim 1, wherein the isolating apparatus (4) comprises a control device, configured to initiate a separation of the battery from the consumer and/or charging apparatus as a function of the outcome of the evaluation by the evaluating unit.

3. The battery management system (1) according to claim 1, wherein the isolating apparatus (4) is connected to the cell monitoring units (3) via the communication system (5), wherein the isolating apparatus (4) is configured to receive operating parameters acquired by the cell monitoring units (3) as data.

4. The battery management system (1) according to claim 1, wherein the communication system (5) is a serial bus system.

5. The battery management system (1) according to claim 1, wherein the battery management system (1) comprises at least one current measuring device (6) for measuring an electric current of the battery, wherein the at least one current measuring device (6) is connected to the isolating apparatus (4), and the isolating apparatus (4) is configured to receive currents measured by the at least one current measuring device (6) as data.

6. The battery management system (1) according to claim 1, wherein the isolating apparatus (4) is configured to receive at least one crash signal as data.

7. The battery management system (1) according to claim 1, further comprising a second communication system (12), wherein the isolating apparatus (4) is connected to the cell monitoring units (3) via the second communication system (12).

8. The battery management system (1) according to claim 7, wherein the second communication system is a communication line (12) connecting the cell monitoring units (3) to one another, wherein data are transmitted from the cell monitoring units (3) via the communication line (12) to the isolating apparatus (4) using a daisy chain principle.

9. The battery management system (1) according to claim 1, wherein the isolating apparatus (4) is configured to generate and/or to monitor an HV interlock signal using received data.

10. The battery management system (1) according to claim 1, wherein the battery management system (1) is connected in part to a high-voltage circuit and in part to a low-voltage circuit, the control device unit (2) exclusively connected to the low voltage circuit.

11. A battery system comprising a rechargeable battery, having a plurality of battery cells, and a battery management system (1) for monitoring and regulating the operation of the battery, wherein the battery management system (1) is a battery management system according to claim 1.
